(19) United States
(12) Patent Application Publication
(10) Pub. No.: US 2014/0282228 A1
(43) Pub. Date: Sep. 18, 2014

(54) Dynamically Enable, Variable Border Area for Touch Solution with a Bezel

(71) Applicant: DELL PRODUCTS L.P., Round Rock, TX (US)

(72) Inventors: Gerald R. Pelissier, Round Rock, TX (US); Vinh X. Bui, Houston, TX (US); Alan Luecke, Austin, TX (US)

(73) Assignee: DELL PRODUCTS L.P., Round Rock, TX (US)

(21) Appl. No.: 13/832,782

(22) Filed: Mar. 15, 2013

(51) Int. Cl. G06F 3/0481

(52) U.S. Cl. CPC G06F 3/0481
USPC 715/788

(57) ABSTRACT

A method and system for managing the active area of a touch-sensitive display is disclosed. A request to resize the active area of a touch-sensitive display is received from a user in the form of a user gesture. The relationship of the current dimensions of the active area to the inside dimensions of a bezel associated with the touch-sensitive display is determined. The request is then processed to initiate active area resizing operations. If the dimensions of the active area are coincident with the inside dimensions of the bezel, then the dimensions of the active area can be reduced. If the dimensions of the active area are not coincident with the inside dimensions of the bezel, then the dimensions of the active area can be increased.

### BACKGROUND OF THE INVENTION

1. Field of the Invention

The present invention relates to the field of information handling systems and more particularly to managing the active area of a touch-sensitive display.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A touch-sensitive display, also known as a touchscreen, is an electronic visual display that can receive user input through simple or multi-touch gestures by the user touching the screen with one or more fingers. In recent years, it has become increasingly common to incorporate touchscreens into a wide variety of information handling systems, including all-in-one personal computers (AIO-PCs), laptops, tablets, portable digital assistants (PDAs), cell phones and other devices. Known touchscreen technologies include resistive, surface capacitive, projected capacitive, infrared, surface acoustic wave (SAW), dispersive signal technology (DST), acoustic pulse recognition, LCD in-cell optical, and force sensing.

A more recent touchscreen technology is optical imaging, which tracks the movement of any object close to the surface of the screen through the use of optical sensors located around the perimeter of the display. These optical sensors, which may be positioned in the corners of the display or around the perimeter of the display, can track the movement of the object, such as a user's fingertip, by detecting the interruption of an infra-red light source that is emitted in a plane across the surface of the screen. In various implementations, the infrared light source may be actively emitted by an infrared LED, or passively provided by one or more reflective surfaces. One advantage of an optical imaging touchscreen is that the user's gestures do not actually have to be made in contact with the display. As a result, three dimensional (3D) user gestures are enabled.

However, optical imaging touchscreens typically require a raised bezel to enclose the various optical sensors, LED bars, filters, or reflector bars used in different implementations. Furthermore, third party software vendors may impose additional configuration or operational requirements on the implementation of optical imaging touchscreens to ensure compatibility with their products. As an example, the Microsoft® Corporation of Redmond, Wash., ensures compatibility with their Windows® products through their Windows Hardware Quality Labs (WHQL) testing. Third party products that pass the WHQL tests are allowed to use a “Certified for Windows” logo, which certifies that the hardware or software has had some share of testing by Microsoft to ensure compatibility. In particular, Microsoft® Windows® operating system (OS) version 8 (Win 8®) WHQL requires any touch implementation that has a raised bezel to also have a 20 mm border around the active display area in order to facilitate ease of operation for edge swipe gestures. As a result, this requirement may also result in additional or undesired industrial design constraints.

### SUMMARY OF THE INVENTION

In accordance with the present invention, a method and system for managing the active area of a touch-sensitive display is disclosed. In various embodiments, user input is monitored to detect a request to resize the active area of a touch-sensitive display. If detected, then a determination is made whether the resizing request is to increase or decrease the size of the active area. The current dimensions of the touchscreen's active area are then determined.

If it was determined that the user request was to decrease the size of the active area, then a determination is made whether the current dimensions of the active area can be further decreased. If so, the dimensions of the active area are decreased. Otherwise, they are not. Conversely, if it was determined that the user request was to increase the size of the active area, then a determination is made whether the current dimensions of the active area can be further increased. If so, the dimensions of the active area are increased. Otherwise, they are not.

In various embodiments, the dimensions of the active area are automatically resized to a predetermined set of dimensions. In one embodiment, the predetermined set of dimensions is coincident with the inside dimensions of the touch-sensitive display's bezel. In one embodiment, the difference between the predetermined set of dimensions and the inside dimensions of the bezel is implemented as an inactive area of the touch-sensitive display. In one embodiment, the inactive area complies with a predetermined certification requirement. In one embodiment, the dimensions of the active area are incrementally resized in predetermined increments.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an information handling system having a system for touchscreen active area management;

FIGS. 2a and 2b show a diagrammatic representation of the resizing of a touchscreen's active area to provide a border between the active area and the touchscreen's bezel;

FIGS. 3a and 3b show a diagrammatic representation of a user gesture used to initiate the resizing of a touchscreen's active area; and

FIG. 4 shows a flowchart of touchscreen active area resizing operations.

### DETAILED DESCRIPTION

A method and system are disclosed for managing the active area of a touch-sensitive display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 1 shows a block diagram of an information handling system having a system for finger tap sequence authentication that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. The I/O devices further include a display device 140 as well as a touch sensitive input device 142. The touch sensitive input device 142 may be a touch pad or may be a touch sensitive type display device. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes an operating system (OS) 116 and in various embodiments may also include a touchscreen active area management system 118 and a web browser 120. In one embodiment, the information handling system 100 is able to download the touchscreen active area management system 118 from the service provider server 142. In another embodiment, the touchscreen active area management system 118 is provided as a service from the service provider server 142.

FIGS. 2a and 2b show a diagrammatic representation of the resizing of a touchscreen's active area in accordance with an embodiment of the invention to provide a border between the active area and the touchscreen's bezel. As used herein, a touchscreen broadly refers to a touch sensitive display that is operable to receive user input through simple or multi-touch user gestures familiar skilled practitioners of the art.

Referring to FIG. 2a, touchscreen 200 includes a bezel 202 and an active area 204. In various embodiments, the touchscreen 200 is an optical imaging touchscreen. In these and other embodiments, the bezel 202 is a raised bezel familiar to those of skill in the art. In certain embodiments, the raised bezel 202 may enclose various optical sensors, LED bars, filters, or reflector bars. In certain embodiments, the bezel 202 is not raised. As used herein, a touchscreen's active area 204 refers to a predetermined area of a touchscreen 200 that is operable to display an image 206 and to receive user input through simple, multi-touch, or three dimensional (3D) user gestures. As shown in FIG. 2a, the dimensions of the touchscreen's current active area 204 are coincident with the inside dimensions of the bezel 204.

In various embodiments, user input is received to initiate resizing operations, which are then performed to resize the current active area 204 of the touchscreen 200. For example, as shown in FIG. 2b, the dimensions of the current active area 204 of the touchscreen 200 have been decreased to result in a resized active area 210. In one embodiment, the dimensions of the resized active area 210 of the touchscreen 200 are automatically decreased to a predetermined set of dimensions.

In one embodiment, the difference between the predetermined set of dimensions and the inside dimensions of the bezel 202 of the touchscreen 200 is implemented as an inactive area 208 of the touchscreen 200. As used herein, an inactive area 208 refers to an area of the touchscreen 200 that is configured to not display an image, such as image 212, or to receive user input through simple or multi-touch user gestures. As likewise used herein, an inactive area 208 of the touchscreen 200 may be referred to as a “border,” a “touchscreen border,” or an “inactive border.” In one embodiment, the inactive area 208 of the touchscreen 200 complies with a predetermined certification requirement. In one embodiment, the certification requirement is for compliance with Microsoft® Corporation's Windows Hardware Quality Labs (WHQL) testing for Windows® operating system (OS) version 8 (Win 8®).

In one embodiment, the image 206 displayed within the current active area 204 of the touchscreen 200 is proportionately resized to be displayed as image 212 within the resized active area 210. In one embodiment, the image 206 displayed within the current active area 204 of the touchscreen 200 is not proportionately resized when it is displayed within the resized active area 210. In this embodiment, the image 206 is cropped according to the inside dimensions of the inactive area 208 of the touchscreen 200.

FIGS. 3a and 3b show a diagrammatic representation of a user gesture implemented in accordance with an embodiment of the invention to initiate the resizing of a touchscreen's active area. In this embodiment, monitoring operations are performed to detect user input requesting that the active area 304 of the touchscreen 300 be resized. If detected, a determination is made whether the resizing request was to increase or decrease the size of the touchscreen's active area. Referring to FIG. 3a, the current dimensions of the active area 304 of the touchscreen 300 is determined, followed by a determination whether the user request was to decrease or increase the size of the touchscreen's active area 304.

As shown in FIG. 3a, a first user prompt 306 is generated and displayed within the current active area 304 of the touchscreen 300 to prompt the user to reduce the current active area 304. In response, the user provides user input through a user gesture 314 to decrease the size of the current active area 304. In turn, the dimensions of the current active area 304 of the touchscreen 300 are decreased to result in a resized active area 310. In one embodiment, the difference between the dimensions of the resized active area 310 and the inside dimensions of the bezel 202 is implemented as an inactive area 308 of the touchscreen 300.

As shown in FIG. 3b, a second user prompt 312 is generated and displayed within the resized active area 310 of the touchscreen 300 to prompt the user to increase the active area 310. In response, the user provides user input through a user gesture 314 to increase the size of the resized active area 310. In turn, the dimensions of the resized active area 310 of the touchscreen 300 are increased. In one embodiment, the dimensions of the resized active area 310 are automatically increased to a predetermined set of dimensions. In one embodiment, the predetermined set of dimensions is coincident with the inside dimensions of the touchscreen's bezel 202. In one embodiment, the dimensions of the resized active area 310 are incrementally resized in predetermined increments.

In various embodiments, the user request is received as a result of one or more user gestures 314, such as a simple, multi-touch, or three dimensional (3D) user gesture 314. As used herein, a 3D user gesture 314 refers to a gesture that includes movement in three dimensions. For example, the user may move their fingertip either towards or away from the current 304 or resized 310 active areas of the touchscreen 300. Skilled practitioners of the art will be familiar with 3D user gestures 314, and realized that various 3D user gestures 314 do not require physical contact with the current 304 or resized 310 active areas. Likewise, 3D user gestures 314 may be combined with simple or multi-touch user gestures 314. In one embodiment, the user gesture 314 includes proximity detection of a user. In another embodiment, the user gesture 314 includes a voice recognition command. In yet another embodiment, the user gesture 314 includes user interaction with a physical control, such as a mechanical switch. Those of skill in the art that many such embodiments of a user gesture 314 are possible and the foregoing are not intended to limit the spirit, scope or intent of the invention.

FIG. 4 shows a flowchart of touchscreen active area resizing operations implemented in accordance with an embodiment of the invention. In this embodiment, touchscreen active area resizing operations are begun in step 402, followed by monitoring for user input requesting that a touchscreen's active area be resized in step 404. A determination is then made in step 406 whether user input from a user requesting the resizing of a touchscreen's active area has been detected. If not, then a determination is made in step 422 whether to continue touchscreen active area resizing operations. If so, then the process is continued, proceeding with step 404. Otherwise, touchscreen active area resizing operations are ended in step 424.

However, if it was determined in step 406 that user input requesting the resizing of a touchscreen's active area was detected, then a determination is made in step 408 whether the resizing request was to increase or decrease the size of the touchscreen's active area. Then, in step 410, the current dimensions of the touchscreen's active area is determined, followed by a determination in step 412 whether the user request was to decrease or increase the size of the touchscreen's active area.

If it was determined in step 412 that the user request was to decrease the size of the touchscreen's active area, then a determination is made in step 414 whether the current dimensions of the active area can be further decreased. As an example, a minimum set of dimensions may be implemented for the touchscreen's active area. If it is determined in step 414 that the dimensions of the touchscreen's active area cannot be further decreased, then the dimensions of the touchscreen's active area are not decreased and the process is continued, proceeding with step 422. Otherwise, the dimensions of the touchscreen's active area are decreased in step 416 and the process is continued, proceeding with step 422.

However, if it is determined in step 412 that the user request was to increase the size of the touchscreen's active area, then a determination is made in step 418 whether the current dimensions of the active area can be further increased. For example, the current dimensions of the active area may be coincident with the inside dimensions of the bezel. If it is determined in step 418 that the current dimensions of the active area cannot be increased, then the dimensions of the touchscreen's active area are not increased and the process is continued, proceeding with step 422. Otherwise, the dimensions of the touchscreen's active area are increased in step 416 and the process is continued, proceeding with step 422. In one embodiment, the dimensions of the touchscreen's active area are automatically increased to a predetermined set of dimensions. In one embodiment, the predetermined set of dimensions is coincident with the inside dimensions of the touchscreen's bezel. In one embodiment, the dimensions of the touchscreen's active area are incrementally resized in predetermined increments.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for managing the active area of a touch-sensitive display, comprising:
receiving user input data from a user, the user input data comprising a request to resize the active area of a touch-sensitive display;
processing active area data to determine the relationship of the current dimensions of the active area to the inside dimensions of a bezel associated with the touch-sensitive display; and
processing the user input data to initiate active area resizing operations.

2. The method of claim 1, wherein the active area resizing operations comprise one member of the set of:
decreasing the dimensions of the active area if the current dimensions of the active area are coincident with the inside dimensions of the bezel; and
increasing the dimensions of the active area if the current dimensions of the active area are not coincident with the inside dimensions of the bezel.

3. The method of claim 1, wherein:
the active area resizing operations automatically resize the dimensions of the active area to a set of predetermined dimensions; and
the difference between the set of predetermined dimensions and the inside dimensions of the touch-sensitive display's bezel comply with a predetermined certification requirement.

4. The method of claim 1, wherein:
the active area resizing operations incrementally resize the dimensions of the active area in predetermined increments.

5. The method of claim 1, wherein:
the touch-sensitive display comprises an optical imaging touchscreen.

6. The method of claim 1, wherein the user input data is received as a result of the performance of at least one member of the set of:
a simple user gesture;
a multi-touch user gesture;
a three dimensional (3D) user gesture;
proximity detection of a user;
a voice recognition command; and
an interaction with a physical control by a user.

7. A system comprising:
a processor;
a data bus coupled to the processor; and
a non-transitory, computer-readable storage medium embodying computer program code for managing the active area of a touch-sensitive display, the non-transitory, computer-readable storage medium being coupled to the data bus, the computer program code interacting with a plurality of computer operations and comprising instructions executable by the processor and configured for:
receiving user input data from a user, the user input data comprising a request to resize the active area of a touch-sensitive display;
processing active area data to determine the relationship of the current dimensions of the active area to the inside dimensions of a bezel associated with the touch-sensitive display; and
processing the user input data to initiate active area resizing operations.

8. The system of claim 7, wherein the active area resizing operations comprise one member of the set of:
decreasing the dimensions of the active area if the current dimensions of the active area are coincident with the inside dimensions of the bezel; and
increasing the dimensions of the active area if the current dimensions of the active area are not coincident with the inside dimensions of the bezel.

9. The system of claim 7, wherein:
the active area resizing operations automatically resize the dimensions of the active area to a set of predetermined dimensions; and
the difference between the set of predetermined dimensions and the inside dimensions of the touch-sensitive display's bezel comply with a predetermined certification requirement.

10. The system of claim 7, wherein:
the active area resizing operations incrementally resize the dimensions of the active area in predetermined increments.

11. The system of claim 7, wherein:
the touch-sensitive display comprises an optical imaging touchscreen.

12. The system of claim 7, wherein the user input data is received as a result of the performance of at least one member of the set of:
a simple user gesture;
a multi-touch user gesture;
a three dimensional (3D) user gesture;
proximity detection of a user;
a voice recognition command; and
an interaction with a physical control by a user.

13. A non-transitory, computer-readable storage medium embodying computer program code, the computer program code comprising computer executable instructions configured for:
receiving user input data from a user, the user input data comprising a request to resize the active area of a touch-sensitive display;
processing active area data to determine the relationship of the current dimensions of the active area to the inside dimensions of a bezel associated with the touch-sensitive display; and
processing the user input data to initiate active area resizing operations.

14. The non-transitory, computer-readable storage medium of claim 13, wherein the active area resizing operations comprise one member of the set of:
decreasing the dimensions of the active area if the current dimensions of the active area are coincident with the inside dimensions of the bezel; and
increasing the dimensions of the active area if the current dimensions of the active area are not coincident with the inside dimensions of the bezel.

15. The non-transitory, computer-readable storage medium of claim 13, wherein:
the active area resizing operations automatically resize the dimensions of the active area to a set of predetermined dimensions; and
the difference between the set of predetermined dimensions and the inside dimensions of the touch-sensitive display's bezel comply with a predetermined certification requirement.

16. The non-transitory, computer-readable storage medium of claim 13, wherein:
the active area resizing operations incrementally resize the dimensions of the active area in predetermined increments.

17. The non-transitory, computer-readable storage medium of claim 13, wherein:
the touch-sensitive display comprises an optical imaging touchscreen.

18. The non-transitory, computer-readable storage medium of claim 13, wherein the user input data is received as a result of the performance of at least one member of the set of:
a simple user gesture;
a multi-touch user gesture;
a three dimensional (3D) user gesture;
proximity detection of a user;
a voice recognition command; and
an interaction with a physical control by a user.
